(19) United States
(12) Patent Application Publication
(10) Pub. No.: US 2018/0228224 A1
(43) Pub. Date: Aug. 16, 2018

(54) Integrated sensory system

(71) Applicant: Elizabeth Radcliffe, Brooklyn, NY (US)

(72) Inventor: Elizabeth Radcliffe, Brooklyn, NY (US)

(21) Appl. No.: 15/932,294

(22) Filed: Feb. 16, 2018

Related U.S. Application Data
(60) Provisional application No. 62/459,758, filed on Feb. 16, 2017.

(51) Int. Cl. A41D 1/04; A41D 3/08; A41D 11/00; A41D 27/20; A41D 27/00; A63B 67/00; A63B 43/00; B32B 5/18; B32B 27/40; B32B 27/34

(52) U.S. Cl. CPC A41D 1/04; B32B 2437/00; A41D 11/00; A41D 27/20; A41D 27/00; A63B 67/002; A63B 43/005; B32B 5/18; B32B 27/40; B32B 27/34; A41D 2400/22; A41D 2400/48; A41D 2400/32; A41D 2600/00; A63B 2209/10; B32B 2375/00; B32B 2377/00; A41D 3/08

(57) ABSTRACT

An integrated sensory system includes a therapeutic compression vest. The vest has a first layer, a second layer and a third layer. The first layer is a loop material, said second layer is a closed cell material or polyurethane and the third layer is a soft material. The first layer is coextensive with the second layer. The vest serves as a basis for the integrated sensory system which is designed to meet a broad-range of multi-dimensional therapeutic. The integrated sensory system includes accessories such as a cape, balls, fidgets, etc. all having hook material to enable selective attachment and release of said accessories from the outer loop layer.

### PRIORITY AND RELATED APPLICATION

This application claims priority to U.S. Provisional Patent Application Ser. No. 62/459,758 filed Feb. 16, 2017, entitled “Integrated Sensory System,” which is hereby incorporated by reference in its entirety.

### FIELD OF THE INVENTION

The present invention relates to therapeutic tools and systems. In particular, the present invention relates to therapeutic garments that provide the wearer with pressure and compression. The garment is simultaneously a system for sensory and creative play.

### BACKGROUND OF THE INVENTION

Individuals with sensory processing or sensory integration issues lack the ability to organize sensations coming from the body and the environment and thus can experience some deficits in daily life. These individuals need a way to calm their bodies and center themselves. Children who have difficulties focusing and/or fidget likely have issues with body awareness. Children who exhibit impulsivity may be sensory seekers, who crave sensory stimulation, even at their own risk. Therapeutic tools exist to help children who lack this sense of body awareness. One such tool used by therapists to treat children with sensory issues are vests. A compression and/or weighted vest is a recognized tool used to calm and achieve balance in individuals having sensory processing issues. In fact, soothing pressure provided by compression and/or weighted vests have long been a staple in the therapeutic collection of tools used with hyper-responsive individuals. These vests have been found to increase body awareness, focus, balance, trunk stability and coordination, while decreasing hyperactivity and impulsivity. Occupational therapists use these vests to compress and/or weigh down the child and provide sensory input. These vests have been found to help certain children increase focus/attention in classroom and promote emotional and behavioral self-regulation.

Numerous compression and/or weighted vests currently exist in the market. The biggest complaint by users and parents of users is that the user gets too hot as these traditional vests are made of neoprene or a closed cell foam. To address the heating problem faced by users of these vests, some have turned to making holes in the neoprene vest, using mesh material to replace the neoprene material, or use a mix of fabrics such as neoprene and mesh at different locations in the vest. However, vests with these different materials either do not fully keep the user cool or do not apply sufficient pressure and tension to give the deep compression pressure needed for therapeutic value. These traditional vests are also difficult for the child to put on and take off. Often the child user will require the help of an adult to get in and out of the vest.

The traditional vests are also very limiting with regards to play and creativity. They provide a function but do not allow a wearer to use the vest in creative self-expressive play. According to distinguished scholar Dr. Doris Bergen, as reported in the Journal of Early Childhood Research and Practice: “There is a growing body of evidence supporting the many connections between cognitive competence and high-quality pretend play. If children lack opportunities to experience such play, their long-term capacities related to metacognition, problem solving, and social cognition, as well as to academic areas such as literacy, mathematics, and science, may be diminished. These complex and multidimensional skills involving many areas of the brain are most likely to thrive in an atmosphere rich in high-quality pretend play.” (Bergen, D. (2002). The role of Pretend Play in Children's Cognitive Development. Journal of Early Childhood Research and Practice, 4(1), retrieved Feb. 15, 2018 at http://ecrp.uiuc.edu/v4n1/bergen.html) In addition, psychologist Lev Vygotsky's ground-breaking work found that interactive, imaginative play is a crucial component of a child's cognitive and behavioral development. “Self-regulation is widely recognized as a critical social-emotional skill underpinning children's abilities to act pro-socially with peers and adults, participate productively in learning activities, and adapt successfully to new or challenging situations.” (Vallotton, C., & Ayoub, C. (2011). Use Your Words: The Role of Language in the Development of Toddlers' Self-Regulation. Early Childhood Research Quarterly, 26(2), 169-181.) According to Vygotsky, during imaginative play, children take on different roles and try out different language uses, all of which help them on the journey from being externally to internally regulated.

What is needed is a vest that provides therapeutic values for sensory integration. What is needed is a vest that provides compression such as deep compression and can also be a weighted vest. What is needed is a vest that is breathable and does not make the wearer or user hot and uncomfortable, so that use can be extended. What is needed is a vest that can be donned and removed by a child without the assistance or strength needed by an adult. What is needed is a vest that would facilitate creativity while also meeting the therapeutic need. What is needed is a vest that provides encourages choice-making, interactive and child-led creative play. What is needed is a vest which meets equally valuable therapeutic and educational goals.

### BRIEF SUMMARY OF THE INVENTION

An integrated sensory system comprises a vest having a breathable front panel and back panel. Each said front and back panel are dimensioned and configured to the wearer's anterior and posterior torso, respectively. Fasteners are employed on the vest at the shoulder regions, side-waist regions and abdomen region. The fasteners enable a user to manipulate tension or compression applied by the vest to the wearer. Each panel is breathable having a first layer or outer layer, a second layer or middle layer and a third layer or inner layer. The first or outer layer is a loop material and is coextensive with the second or middle layer. The second or middle layer is an open cell material or polyurethane. The inner or third layer is a smooth material. Each of the panels offers pockets located at the top of the child's hips to allow for proper placement of therapeutic weights, if needed, and which may be easily removed, so that the child can wear the vest continuously (weighted garments may only be worn for short periods of time safely).

The vest serves as a basis for the integrated sensory system which is designed to meet a broad-range of multi-dimensional therapeutic needs. Accessories may include a cape, balls, fidgets, etc. all having hook material to enable selective attachment to and release of said accessories from the outer loop layer. This integrated sensory system thus facilitates choice-making and is instrumental in encouraging child-led and interactive, imaginative play, which is, a valuable part of the therapeutic process.

### BRIEF DESCRIPTION OF THE DRAWING

FIG. 1 is a front view of a vest of an integrated sensory system.

FIG. 2 is a rear view of the vest.

FIG. 3A is an inside view of vest in an open and exploded position.

FIG. 3B is a rear view of the vest in an open and exploded position.

FIG. 4 is a cross-sectional view generally taken along line 4-4 in FIG. 1.

FIG. 5 is a perspective view of the integrated sensory system having play tools and a cape.

### DETAILED DESCRIPTION OF THE INVENTION

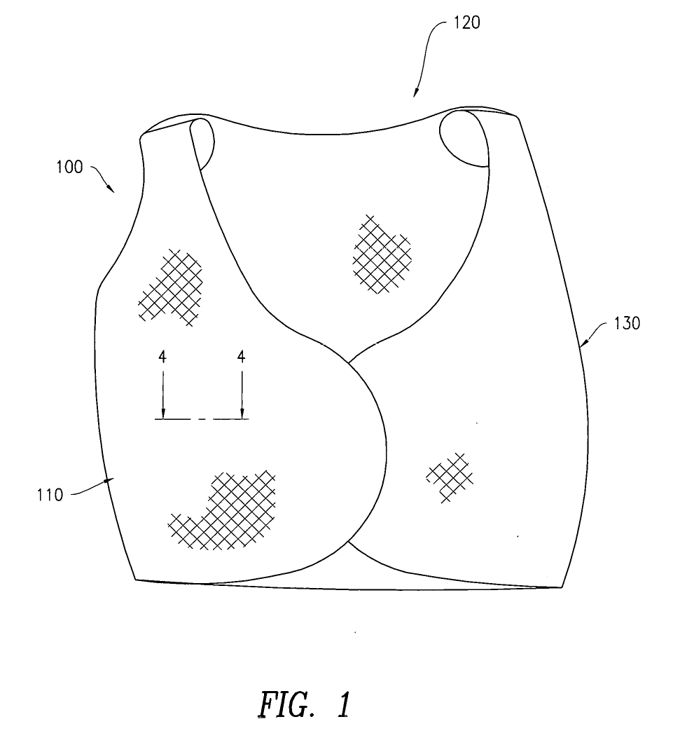

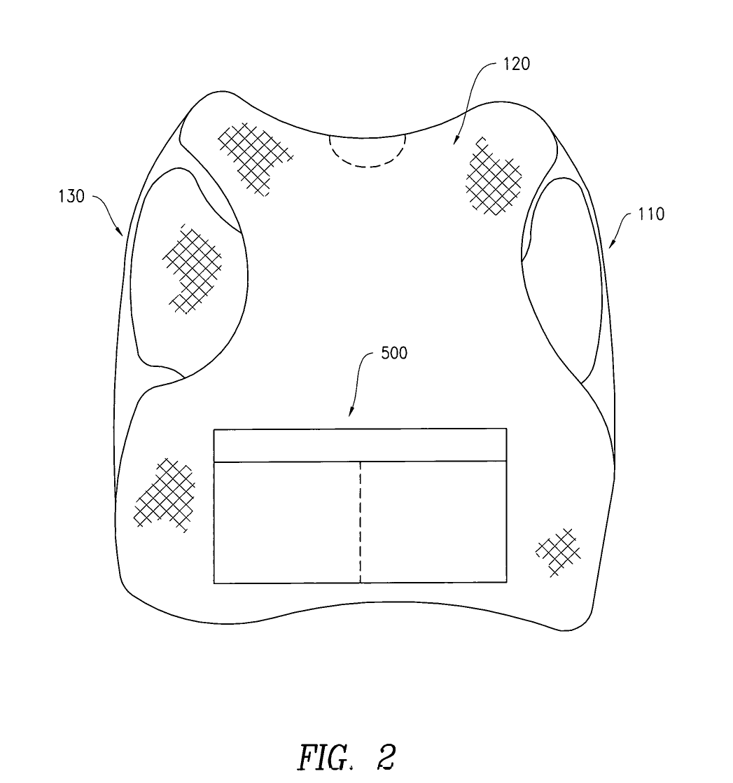

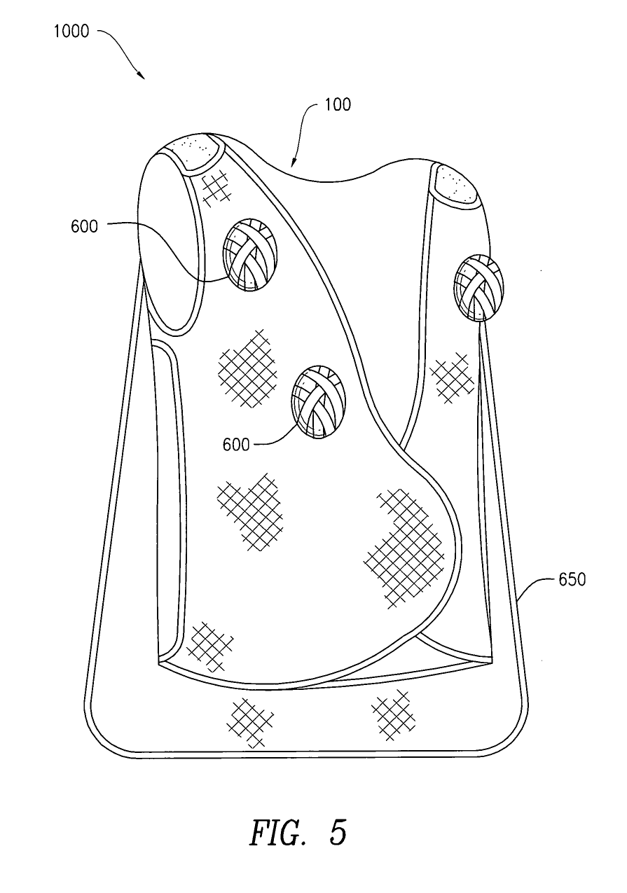

FIGS. 1 and 5 shows a front view of a therapy compression garment in the form of a compression vest 100 of the integrated sensory system 1000. The vest 100 is dimensioned and configured to the anterior and posterior torso of a wearer. The vest 100 includes a front panel comprising a right panel 110 and a left panel 130 and a back panel 120. FIG. 2 shows the rear view of the vest 100.

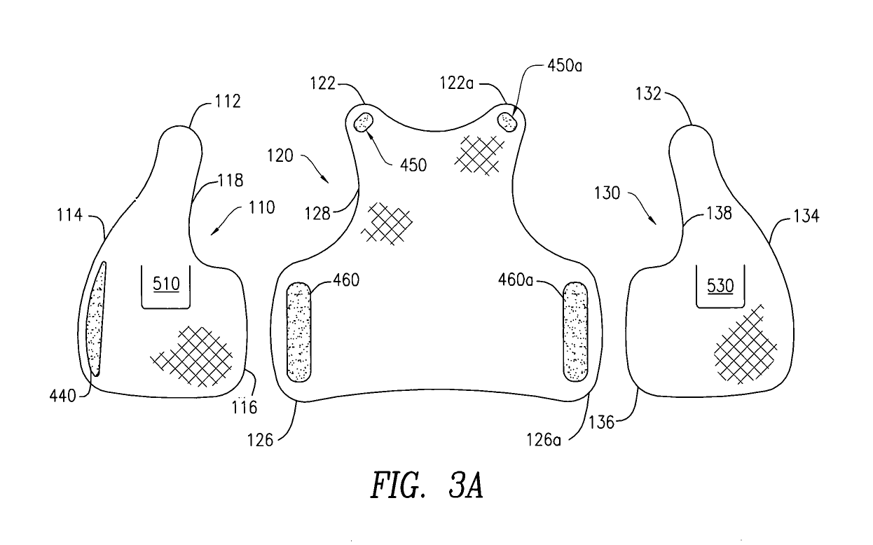

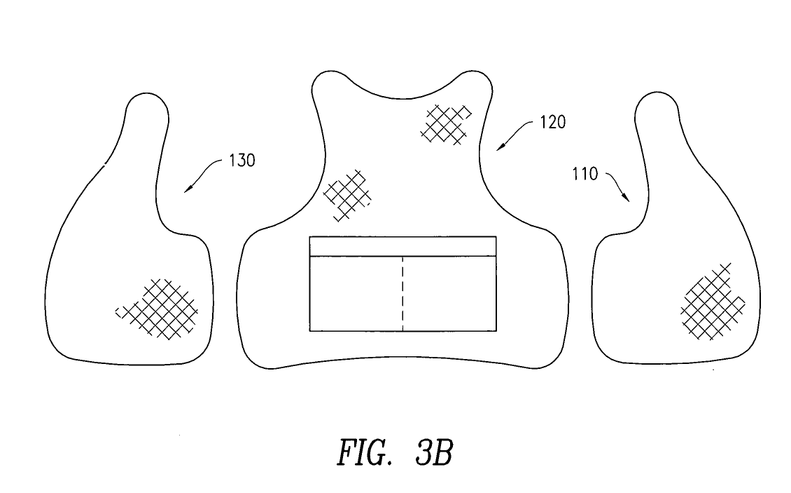

FIGS. 3A and 3B, show an exploded inside view and an exploded outside view of the vest 100, respectively. Looking at FIGS. 3A and 3B, the right panel 110 is shown having a right shoulder portion 112, a right-central waist portion 114, a right-side waist portion 116 and arm opening 118. Similarly, the left panel 130 has a left shoulder portion 132, a left-central waist portion 134, left-side waist portion 136 and arm opening 138. Fastener 440 may be disposed on right panel 110 as shown. Alternatively, fastener 440 may be disposed on left panel 130. The back panel 120 has right shoulder flap 122, left shoulder flap 122a, arm openings 128, right waist flap 126 and left waist flap 126a. Fasteners 450, 450a, 460, 460a are disposed on the surface of the inside of the back panel 120.

Each said right-central waist portion 114 and said left-central waist portion 134 have curved edges. The curved edge allows a child-user to readily grasp and manipulate the right-central waist portion 114 and the left-central waist portion 134 of the vest 100. For instance, looking at FIG. 1, a user would place their hand along the edge of right-central waist portion 114 and pull the right panel 110 up or down to release fastener 440 from the surface of left panel 130.

FIG. 3A shows two pockets 510, 530 provided on the inside of the vest 100. FIGS. 2 and 3B show two outside pockets 500 which are provided on the back of the vest 100. The pockets 510, 530 sit just above the hips. The pockets may be used to allow the wearer to retain weights to add pressure to the wearer. In one embodiment, the pockets 510, 530 and 500 are designed to fit 4″×4″ weights. The pockets are also suited to retain emergency contact information and personal items such as toys, buttons, medals, dolls, bottles, small instruments and so on. Though the vest 100 is shown with pockets each 510, 530 and 500, other number, size or placement of pockets are feasible.

The vest 100 provides a five-way fit enabled by the fasteners 440, 450, 450a, 460, 460a at each the central waist region, shoulder regions and side waist areas, respectively. The user is allowed to customize the vest 100 to the wearers' body shape and comfort by adjusting the position of any or all of the fasteners. The five-way fit also allows the user to control the degree of pressure or tension imparted by the vest 100 to the wearer.

All five or fewer points on the vest 100 can be selectively adjusted to the wearer's body shape and to fine-tune the amount of compression provided to the torso of the wearer. It can be easily adjusted for different days or even over the course of a single day. The significance of the selectively adjustable five-way fit is great as the vest 100 can accommodate prosthetic, orthotic or other unique needs of the user. For instance, this range of adjustments can be necessary for users with medports, or any unique accommodations required.

The following examples in conjunction with FIGS. 1 and 3A, explain how an individual wearing vest 100 adjusts the vest for compression and comfort. For instance, if the wearer wanted to add pressure at the light shoulder region, right shoulder flap 122 would be peeled up or down, or in a north and south direction, away from the right shoulder portion 112 of the right panel 110 to release fastener 450 from the surface of right panel 110. Then fastener 450 of right shoulder flap 122 would then be stretched down over the right shoulder portion 112 of the right panel 110 and releasably attached further down the front surface of right shoulder portion 112. Similar action would occur to tighten the vest 100 over the left shoulder region. Opposite action would be taken to release pressure applied by the vest 100 at either shoulder region. Regardless of which shoulder flap 122, 122a is being used to increase or decrease tension, the shoulder flap 122, 122a that is being moved can be stretched in a straight vertical direction or in a non-straight or off-center skewed direction, to place fastener 450 slightly to the left or the right of the vertical plane. This allows the vest 100 to accommodate the unique needs of the user.

If the wearer wanted to increase tension or pressure at the right-side waist region, the edge of right waist flap 126 would be peeled up or down, or in a north-south direction, away from the right-side waist portion 116 of the right panel 110 to release fastener 460 from the surface of right panel 110. The right waist flap 126 would be stretched over the front of right panel 110, specifically over right-side waist portion 116, in the direction headed to right central waist portion 114. Fastener 460 would then be releaseably attached anywhere between the right-side waist portion 116 and the right-central waist portion 114. Similar action would occur to tighten the vest 100 over the left-side waist region. Opposite action would be taken at each the right-side or left-side regions to decrease tension from the vest 100 as applied to the user. Regardless of which waist region is in need of increased or decreased tension, the side-waist flap 126 or 126a that is being moved can be stretched in a straight horizontal direction or in a non-straight or off-center skewed direction, to place fastener 460 slightly above or below the horizontal plane. This allows the vest 100 to accommodate the unique needs of the user.

If the user chooses to increase tension imparted by the vest 100 at the abdominal region, the user would take right-central waist portion 114 and release fastener 440 from the surface of left panel 130. To release fastener 440 from the surface of left panel 130, the user must peel the fastener 440 up or down, or in a north-south direction. Then right-central waist portion 114 would be stretched further over left panel 130, at a distance away from left-central waist portion 134 and a distance closer to left-side waist edge 136. To decrease tension at the abdomen region, the user would release fastener 440, as noted above, and move right-central waist portion 114 and fastener 440 from its position on the surface of left panel 130 and move the fastener 440 in a direction closer to left-central waist portion 134 and away from left-side waist edge 136. Regardless of which panel 110, 130 is being used to increase or decrease tension, the waist portion 114 or 134 that is being moved can be stretched in a straight horizontal direction or in a non-straight or off-center skewed direction, to place fastener 440 slightly above or below the horizontal plane. This allows the vest 100 to accommodate the unique needs of the user.

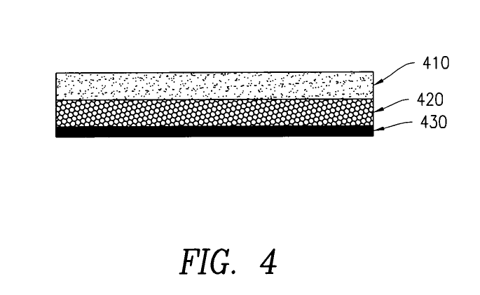

The vest 100 is made of breathable material which allows the user to stay cool by preventing the accumulation or retention of heat when worn. FIG. 4 shows the layers of the breathable material in vest 100 as taken along line 4-4 in FIG. 1. The breathable material comprises a first layer or outer layer 410, a second layer or middle layer 420 and a third layer or inner layer 430. In some embodiments the breathable material comprises, all three layers. In other embodiments, the breathable material is the first layer or outer layer 410 and the second layer or middle layer 420.

The third or inner layer 430 is adjacent the skin of the wearer and thus must be a comfortable and smooth material. In one embodiment, the inner layer is nylon. The inner nylon layer 130 is has an open nylon stitch for comfort. Fasteners 450, 450a, 460, 460a, 440 disposed at the shoulder region, side-waist regions and central-waist or abdomen region, respectively, are disposed on the inner nylon layer 430.

In one embodiment, fasteners 440, 450, 450a, 460, 460a are selectively releasable. In one embodiment, fasteners 440, 450, 450a, 460, 460a include but are not limited to hook material of hook and loop mating material such as Velcro®. Fasteners 450, 450a are disposed at the right and left shoulder flaps 122 and 122a, respectively, fasteners 460, 460a are disposed at the right-side and left-side waist flaps 126 and 126a, respectively, and fastener 440 is disposed at the right-central waist portion 114. In some embodiments, the fastener 440 is on left-central waist portion 134, in other embodiments the fastener 440 may be disposed on both right-central waist portion 114 and left-central waist portion 134.

As described in the examples above, in one embodiment, the fasteners 440, 450, 450a, 460, 460a have a strong tensile strength and a weak sheer strength. In one embodiment, fasteners 440, 450, 450a, 460, 460a are hook of mating hook and loop material such as Velcro®. For instance, the fasteners 440, 450, 450a, 460, 460a or hook material, is turned or pulled away from the front panels 110, 130 by pulling the hook material down in a vertical (up and down) direction so that the wearer can open the vest 100. Alternatively, the wearer can pull the fasteners up in a vertical (up and down) direction. The weak sheer strength facilitates the release of the fasteners 440, 450, 450a, 460, 460a from the front panels 110, 130 in this up/down or vertical direction. This also means the vest 100 does not pull open with side to side pressure due to the strong tensile strength.

The second or middle layer 420 is disposed over the inner layer 430. In one embodiment, the middle layer is coextensive with the inner layer 430. In another embodiment the inner layer 430 is laminated to the middle layer 420. In one embodiment, the middle layer 420 is a breathable material that does not trap air or body heat. In a preferred embodiment, the middle layer is an open cell material such as open cell foam or polyurethane. Open cell foam has tiny cells of the foam that are not completely closed. They are broken, and air fills the “open” space inside the material. The open cell foam is weaker or softer feeling than closed-cell foam.

Middle layer 420 is breathable, unlike neoprene. The middle layer 420 however has the same stretch and compression properties as neoprene as shown in Table I, Open Cell Technical Specifications:

TABLE 1
Open Cell Technical Specifications

| Test Item | Test Result | Test Method |
|---|---|---|
| Elongation at Breaking | Warp: 28.90% | ASTM D4964 |
| | Weft: 31.16% | |
| Breathability | 296 cm³/cm²/s | N/A |
| Elongation (Hand Stretch) | Warp: 110% | |
| | Width: 65% | |
| Wales | 23 | |
| Courses | 31 | |

In one embodiment, the middle layer has a low intrinsic clothing insulation value, clo value (I_{CL} value). Clo value is a measure of the thermal resistance value of clothing as it relates to human comfort when wearing the clothing. It indicates the insulation provided by the clothing alone. In some cases, the vest 100, through middle layer 420, has a do value of less than about 0.30, in other embodiments the vest 100, through middle layer 420, has a clo value of between about 0.08 and about 0.30.

The first or outer layer 410 is disposed over the middle layer 420. In one embodiment the outer layer 410 is coextensive with the middle layer 420. In another embodiment the outer layer 410 is laminated to the middle layer 420. In one embodiment, the outer layer 410 is a loop material. In a preferred embodiment, the loop material is an unbroken loop material. The outer layer 410 enables the user to selectively adjust the fasteners 440, 450, 450a, 460, 460a in numerous ways about the outside of the vest 100 while donned by the wearer.

The outer layer 410 can be laminated, heat laminated, adhesively bonded, molded, sewn or otherwise attached onto the middle layer 420. Alternatively, the inner layer 410 may also be bonded as an integral part of the middle layer 420. Other methods of securing to or forming with the inner layer 410, or unbroken loop fabric layer, onto the middle layer 420 can be used as well. Unbroken loop provides high pile, high strength and is a surface compatible with hook material/fasteners of hook and loop fasteners such as Velcro®. Thus, the outer layer 410 enables a user to allow other devices to be instantly connected using hook material/fasteners. For instance, the wearer may add play tools with hook material to the outside of the vest 100 which provides a sense of comfort and a platform to serve as a creative play experience system. Such play tools include patches, pockets, pouches, fidgets, wound Velcro® balls 600, etc., so long as each item has hook material disposed thereon.

Other play tools that can be used with the vest 100 include a tear-away cape 650, FIG. 5. The cape 650 would have hook material at points on the cape 600 to releasably fasten the cape 650 to the outer layer 410 on the surface of the vest 100. Additional accessories include sensory packs that are tools to permit a user, such as a child, with choice making, executive functioning, gross and fine motor skills, and self-esteem practice. All accessories enable a user to create their own design (child-led creative play) to reflect their own personality. Owing to the use of the loop material at the outer layer 410, the above-mentioned accessories can be placed anywhere on the vest 100 when the accessories employ hook material.

Looking at FIG. 5, in one embodiment, the vest 100 of the integrated sensory system 1000 is part of a play scheme. Vests 100 are donned by two users, User A and User B and balls 600 that are fully covered with hook material are provided to each user. In some embodiments, the ball 600 is a Velcro® strip wound into a ball shape displaying the hook portion on the surface of the ball 600. The users of the vest 100 each have their own colored set of balls 600 that are fully covered with hook material and a ball-toss game or paintball-type game materializes. For instance, User A tosses the hook covered balls 600 to the vest 100 worn by User B and tries to stick such ball sticks to the vest 100 and vice versa. Using the paint ball game as an example, the vest 100 becomes a tool for motor planning, planes of movement, eye-hand coordination, social interaction, catch and release, etc., as well as providing all of the therapeutic value of deep compression vest (optionally weighted). Thus, as shown and described the vest 100 is the base of the integrated sensory system designed to meet a broad-range of multi-dimensional therapeutic goals. Thus, the vest 100 is designed to meet multiple goals simultaneously.

While certain embodiments and applications of this invention have been shown and described, it will be apparent to those skilled in the art that many more modifications are possible without departing from the inventive concepts herein described. The invention, therefore, is not to be restricted except as is necessary by the prior art.

I claim:

1. An integrated sensory system comprising:
a therapeutic compression vest for wear by a wearer, said vest having,
a breathable front panel, said front panel dimensioned and configured to the wearer's anterior torso, said front panel having
a right panel, said right panel having a right shoulder portion, a right-side waist portion and a right-central waist portion, and
a left panel, said left panel having a left shoulder portion, a left-side waist portion and a left-central waist portion;
a breathable back panel, said back panel dimensioned and configured to the wearer's posterior torso, said back panel having a left shoulder flap, a right shoulder flap, a left-side waist flap, a right-side waist flap; and
selectively fastenable fasteners connecting each said right shoulder portion with said right shoulder flap covering a wearer's right shoulder region, said left shoulder portion with said left shoulder flap covering the wearer's left shoulder region, said right-side waist portion with said right waist flap covering the wearer's right-side waist region, said left-side waist portion with said left waist flap covering the wearer's left-side waist region, said right-central waist portion with said left-central waist portion covering the wearer's abdomen region such that pressure is adjustably applied to the wearer's torso at each said right shoulder region, left shoulder region, right-side waist region, left-side waist region and abdomen of the wearer region,
wherein said vest has a do value of less than about 0.30.

2. The garment of claim 1, wherein said selectively fastenable fasteners are hook material.

3. The garment of claim 1, wherein said vest has a do value of between about 0.08 and about 0.3.

4. The garment of claim 1, wherein said breathable front panel and said breathable back panel each have a first layer and a second layer, said first layer is an outer surface of the vest.

5. The garment of claim 4, wherein said second layer is an open cell material.

6. The garment of claim 4, wherein said second layer is polyurethane.

7. The garment of claim 4, wherein said first layer is a loop material.

8. The garment of claim 4, wherein said breathable front panel and said breathable back panel further comprises a third layer adjacent said second layer, said third layer is an inner surface of the vest disposed against the torso of the wearer.

9. The garment of claim 8, wherein said third layer is a soft material.

10. The garment of claim 9, wherein said soft material is nylon.

11. The garment of claim 4, wherein said first layer is coextensive with the second layer.

12. An integrated sensory system comprising:
a therapeutic compression vest, said garment having loop material disposed on an outer surface of the garment;
a cape, said cape having hook material disposed on at least one point on said cape to removably attach said cape to said therapeutic compression vest; and
at least one therapeutic play tool, said tool having hook material disposed on at least one point of said tool, said tool removably attachable to said therapeutic compression vest.

13. A method of therapeutic play comprising:
donning a first therapeutic compression vest by a first wearer, said first therapeutic compression vest having an outer layer and a middle layer, said outer layer is an unbroken loop material layer and said middle layer is an open cell material;
donning a second therapeutic compression vest by a second wearer, said second therapeutic compression vest having an outer layer and a middle layer, said outer layer is an unbroken loop material layer and said middle layer is an open tell material; and
providing play tools with hook material disposed thereon, said play tools releaseably attachable to said outer unbroken loop material of said garment.
